(19) United States
(12) Patent Application Publication
(10) Pub. No.: US 2024/0054180 A1
(43) Pub. Date: Feb. 15, 2024

(54) FAST MATRIX MULTIPLICATION FOR BINARY AND TERNARY CONVOLUTIONAL NEURAL NETWORKS ON ARM CENTRAL PROCESSING UNIT

(71) Applicant: Smart Engines Service, LLC, Moscow (RU)

(72) Inventors: Anton Vsevolodovich TRUSOV, Moscow (RU); Elena Evgenyevna LIMONOVA, Moscow (RU); Dmitry Petrovich NIKOLAEV, Moscow (RU); Vladimir Viktorovich ARLAZAROV, Moscow (RU)

(21) Appl. No.: 18/210,395

(22) Filed: Jun. 15, 2023

(30) Foreign Application Priority Data
Aug. 10, 2022 (RU) 2022121772

(51) Int. Cl. G06F 17/16; G06F 7/49

(52) U.S. Cl. CPC G06F 17/16; G06F 7/49

(57) ABSTRACT

No computationally efficient CPU-oriented algorithms of ternary and ternary-binary convolution and/or matrix multiplication are available. Accordingly, a microkernel is disclosed for high-performance matrix multiplication of binary, ternary, and ternary-binary matrices for central processing units (CPUs) with the Advanced Reduced Instruction Set Computer (RISC) Machine (ARM) v8 architecture.

### CROSS-REFERENCE TO RELATED APPLICATIONS

The present application claims priority to Russian Application No. 2022121772, filed on Aug. 10, 2022, which is hereby incorporated herein by reference as if set forth in full.

### BACKGROUND

### Field of the Invention

The embodiments described herein are generally directed to neural networks, and, more particularly, to fast matrix multiplication for binary and ternary convolutional neural networks on a central processing unit (CPU), which, for example, implements the Advanced Reduced Instruction Set Computer (RISC) Machine (ARM) architecture.

### Description of the Related Art

Convolutional neural networks (CNNs) are the primary tool for solving various computer-vision problems, such as pattern recognition (Ref1), object detection (Ref2, Ref3), semantic segmentation (Ref4), and others. New transformer-based (Ref5, Ref6) or deep multilayer perceptron (MLP) based (Ref7, Ref8) neural networks sometimes outperform CNNs on challenging datasets. However, these neural networks are usually harder to train, have more parameters, and require more computational resources for inference (Ref8, Ref9). Thus, CNNs remain necessary for practical applications.

The high performance of CNNs is essential for on-device intelligence systems, which solve computer-vision problems directly on a mobile device (e.g., smartphone), without the transmission of information to an external server. On-device intelligence systems provide faster solutions, are more energy efficient, and are more secure (Ref10).

The most computationally challenging operation in a CNN is a discrete convolution of a feature map with a convolution kernel. One computationally efficient approach is based on general matrix multiplication (GeMM). Using this approach, the feature map and the convolution kernel are transformed to matrices and then multiplied, for example, with the help of optimized Basic Linear Algebra Subprograms (BLAS) libraries (Ref11). The most common method for transforming a feature map to a matrix is the image-to-column (im2col) method. Unfortunately, the im2col method suffers from significant memory overhead. Thus, several more resource-efficient methods have been proposed (Ref12, Ref13).

GeMM-based approaches are not the only efficient algorithms for discrete convolution. For example, field-programmable gate arrays (FPGAs), application-specific integrated circuits (ASICs), and graphics processing units (GPUs) can benefit from a reduced number of multiplications using Winograd's minimal filtering algorithms (Ref14), and also use more straightforward algorithms (Ref15). On central processing units (CPUs), it is critical to optimize data flow in memory, so that the number of cache misses is low and data-parallel execution with Single Instruction Multiple Data (SIMD) instructions is possible. This can be achieved with the help of just-in-time code generation of direct convolution for specific kernel sizes (Ref16). However, all of these algorithms are specific to devices and/or convolution parameters. Thus, GeMM-based algorithms are still widely used.

One of the most efficient ways to speed up and reduce the memory footprint of a CNN is to replace floating-point values of weights and activations with integers. This process is called quantization, and a neural network with integer weights is referred to as a quantized neural network (QNN) (Ref10). 8-bit quantization allows for a four-fold reduction of network size and a significant increase in speed on mobile CPUs, while maintaining a quality that is close to full-precision neural networks (Ref17). 4-bit QNNs demonstrate a noticeable drop in recognition quality on challenging tasks (Ref18, Ref19). However, 4-bit quantization can be used to significantly accelerate CPU inference of small CNNs (Ref20).

The most memory-efficient quantization is binarization. In binary QNNs (BNNs), weights and activations only take the value of either 1 or −1, and require a single bit for storage. In BNNs, convolutions and matrix multiplications can be computed using only XOR/XNOR and bit-count operations (Ref21). This makes BNNs exceptionally computationally efficient, especially on FPGAs and ASICs. There is also a CPU implementation of BNNs available in the daBNN library (Ref22).

Although training techniques for BNNs have improved in the past few years (Ref23, Ref24), they still show a significant gap in accuracy, relative to full-precision neural networks. Ternary neural networks (TNNs) allow weights and activation functions to take the value of either 1, 0, or −1 (Ref25). TNNs show higher quality than BNNs and can be efficiently implemented on ASICs and FPGAs (Ref26, Ref27). Ternary-binary networks (TBNs) have ternary activation functions (i.e., activation functions can take the value of either 1, 0, or −1) and binary weights (i.e., weights can take the value of either 1 or −1), and are between BNNs and TNNs in terms of computational complexity, but exhibit almost the same recognition quality as TNNs (Ref28). However, no computationally efficient CPU-oriented algorithms of ternary and ternary-binary convolution and/or matrix multiplication are available.

### SUMMARY

Accordingly, systems, methods, and non-transitory computer-readable media are disclosed for high-performance matrix multiplication of binary, ternary, and ternary-binary matrices for CPUs with the Advanced Reduced Instruction Set Computer (RISC) Machine (ARM) v8 architecture.

In an embodiment, a method comprises using an Advanced Reduced Instruction Set Computer (RISC) Machine (ARM) processor to execute a microkernel to perform matrix multiplication on a left matrix A of size m×k and a right matrix B of size k×n, wherein values in the left matrix A are represented using two-bit encoding, the microkernel comprising: in an Ablock buffer, for each column in the left matrix A, interleaving m x-bit values from a set of first bits in the two-bit encoding with m x-bit values from a set of second bits in the two-bit encoding; and, over k iterations, loading a column of x-bit elements from the Ablock buffer into one or more a registers, loading a row of x-bit elements from a Bblock buffer, in which a representation of the right matrix B is stored, into one or more b registers, computing a product of each element in the one or more b registers with all elements in the one or more a registers, and accumulating the products in a Cblock buffer.

The microkernel may be executed during convolution of a feature map with a convolution kernel during operation of a quantized neural network. The quantized neural network may be a ternary neural network with ternary activation functions and ternary weights.

The microkernel may further comprise, prior to the k iterations, in the Bblock buffer, for each row in the right matrix B, interleaving n x-bit values from a set of first bits in the two-bit encoding with n x-bit values from a set of second bits in the two-bit encoding, wherein m=16, n=8, and x=8, wherein the one or more a registers consist of two 128-bit registers, and wherein the one or more b registers consist of a single 128-bit register.

Computing a product may comprise using AND and OR operations. Accumulating the products may comprise summing first and second bits of the two-bit encoding in the product using a population-count-per-byte (CNT) instruction in an ARM architecture, and subtracting first and second bits of the two-bit encoding in the product using a signed-subtract-long (SSUBL) instruction in the ARM architecture. Accumulating the products may further comprise accumulating results of the summing and subtracting using an add (ADD) instruction in the ARM architecture.

The quantized neural network may be a ternary-binary neural network with ternary activation functions and binary weights. The microkernel may further comprise, prior to the k iterations: packing n columns of right matrix B into x-bit values to create an x-bit matrix; and storing the x-bit matrix in row-major order in the Bblock buffer, wherein m=16, n=8, and x=8, wherein the one or more a registers consist of two 128-bit registers, and wherein the one or more b registers consist of a single 64-bit register.

Computing a product may comprise using OR, AND, and ORN operations. Accumulating the products may comprise summing first and second bits of the two-bit encoding in the product using a population-count-per-byte (CNT) instruction in an ARM architecture, and subtracting first and second bits of the two-bit encoding in the product using a signed-subtract-long (SSUBL) instruction in the ARM architecture. Accumulating the products may further comprise accumulating results of the summing and subtracting using an add (ADD) instruction in the ARM architecture.

In an embodiment, a method comprises using an Advanced Reduced Instruction Set Computer (RISC) Machine (ARM) processor to execute a microkernel to perform matrix multiplication on a left matrix A of size m×k and a right matrix B of size k×n, wherein values in both the left matrix A and the right matrix B are represented using one-bit encoding, the microkernel comprising: packing m row of left matrix A into x-bit values to create a first x-bit matrix; storing the first x-bit matrix in column-major order in an Ablock buffer; packing n columns of right matrix B into x-bit values to create a second x-bit matrix; storing the second x-bit matrix in row-major order in a Bblock buffer; and, over k iterations, loading a column of x-bit elements from the Ablock buffer into one or more a registers, loading a row of x-bit elements from the Bblock buffer into one or more b registers, computing a product of each element in the one or more b registers with all elements in the one or more a registers, and accumulating the products in a Cblock buffer. In an embodiment, m=16, n=8, and x=8, wherein the one or more a registers consist of a single 128-bit register, and wherein the one or more b registers consist of a single 64-bit register.

Computing the product may comprise an XOR operation using a bitwise exclusive-OR (EOR) instruction in an ARM architecture. Accumulating the products may comprise counting a number of 1-bytes in the product using a population-count-per-byte (CNT) instruction in the ARM architecture. Accumulating the products may further comprise accumulating the counted numbers of 1-bytes using a signed-add-wide (SADDW) instruction in the ARM architecture.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example processing system, by which one or more of the processes described herein, may be executed, according to an embodiment;

FIGS. 2A and 2B illustrate matrix multiplication using a binary microkernel, according to an embodiment;

FIGS. 3A and 3B illustrate matrix multiplication using a ternary microkernel, according to an embodiment; and

FIGS. 4A and 4B illustrate matrix multiplication using a ternary-binary microkernel, according to an embodiment.

### DETAILED DESCRIPTION

In an embodiment, systems, methods, and non-transitory computer-readable media are disclosed for high-performance matrix multiplication of binary, ternary, and ternary-binary matrices for CPUs with the ARMv8 architecture. This high-performance matrix multiplication may be used in convolutional and fully connected (linear) layers of BNNs, TNNs, and TBNs to obtain computationally efficient inference in such neural networks on mobile devices. The disclosed algorithms may use binary logic operations, instead of multiplications, and accumulate their products in 16-bit integer values. This enables full advantage of data-parallel computing with the help of the NEON™ SIMD architecture extension of ARM CPUs.

After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

### 1. System Overview

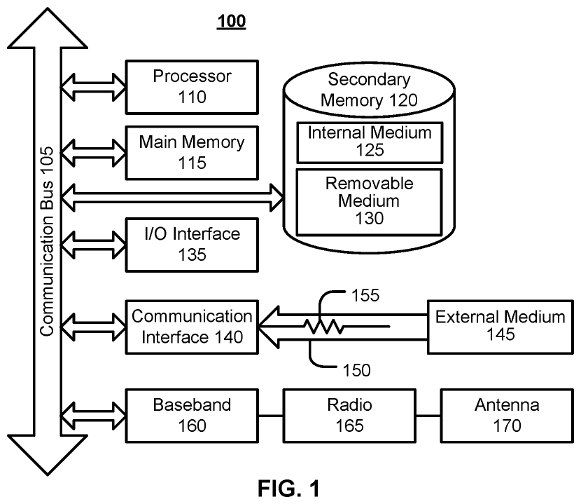

FIG. 1 is a block diagram illustrating an example wired or wireless system 100 that may be used in connection with various embodiments described herein. For example, system 100 may be used as or in conjunction with one or more of the functions, processes, or methods (e.g., to store and/or execute one or more software modules) described herein. System 100 can be a server or any conventional personal computer, a mobile device, such as a smartphone, or any other processor-enabled device that is capable of wired or wireless data communication. Other computer systems and/or architectures may be also used, as will be clear to those skilled in the art.

System 100 preferably includes one or more processors 110. Processor(s) 110 may comprise a CPU implementing the ARM (e.g., ARMv8) architecture. Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a slave processor subordinate to the main processing system (e.g., back-end processor), an additional microprocessor or controller for dual or multiple processor systems, and/or a coprocessor. Such auxiliary processors may be discrete processors or may be integrated with processor 110. Examples of processors which may be used with system 100 include, without limitation, any of the processors (e.g., Pentium™, Core i7™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, and/or the like.

Processor 110 is preferably connected to a communication bus 105. Communication bus 105 may include a data channel for facilitating information transfer between storage and other peripheral components of system 100. Furthermore, communication bus 105 may provide a set of signals used for communication with processor 110, including a data bus, address bus, and/or control bus (not shown). Communication bus 105 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPM), IEEE 696/S-100, and/or the like.

System 100 preferably includes a main memory 115 and may also include a secondary memory 120. Main memory 115 provides storage of instructions and data for programs executing on processor 110, such as one or more of the functions and/or modules discussed herein. It should be understood that programs stored in the memory and executed by processor 110 may be written and/or compiled according to any suitable language, including without limitation C/C++, Java, JavaScript, Perl, Visual Basic, .NET, and the like. Main memory 115 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 120 is a non-transitory computer-readable medium having computer-executable code (e.g., any of the software disclosed herein) and/or other data stored thereon. The computer software or data stored on secondary memory 120 is read into main memory 115 for execution by processor 110. Secondary memory 120 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 120 may optionally include an internal medium 125 and/or a removable medium 130. Removable medium 130 is read from and/or written to in any well-known manner. Removable storage medium 130 may be, for example, a magnetic tape drive, a compact disc (CD) drive, a digital versatile disc (DVD) drive, other optical drive, a flash memory drive, and/or the like.

In alternative embodiments, secondary memory 120 may include other similar means for allowing computer programs or other data or instructions to be loaded into system 100. Such means may include, for example, a communication interface 140, which allows software and data to be transferred from external storage medium 145 to system 100. Examples of external storage medium 145 include an external hard disk drive, an external optical drive, an external magneto-optical drive, and/or the like.

As mentioned above, system 100 may include a communication interface 140. Communication interface 140 allows software and data to be transferred between system 100 and external devices (e.g. printers), networks, or other information sources. For example, computer software or data may be transferred to system 100, over one or more networks (e.g., including the Internet), from a network server via communication interface 140. Examples of communication interface 140 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 100 with a network or another computing device. Communication interface 140 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 140 are generally in the form of electrical communication signals 155. These signals 155 may be provided to communication interface 140 via a communication channel 150. In an embodiment, communication channel 150 may be a wired or wireless network, or any variety of other communication links. Communication channel 150 carries signals 155 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (e.g., computer programs, such as the disclosed software) is stored in main memory 115 and/or secondary memory 120. Computer-executable code can also be received via communication interface 140 and stored in main memory 115 and/or secondary memory 120. Such computer-executable code, when executed, enable system 100 to perform the various functions of the disclosed embodiments as described elsewhere herein.

In this description, the term “computer-readable medium” is used to refer to any non-transitory computer-readable storage media used to provide computer-executable code and/or other data to or within system 100. Examples of such media include main memory 115, secondary memory 120 (including internal memory 125 and/or removable medium 130), external storage medium 145, and any peripheral device communicatively coupled with communication interface 140 (including a network information server or other network device). These non-transitory computer-readable media are means for providing software and/or other data to system 100.

In an embodiment that is implemented using software, the software may be stored on a computer-readable medium and loaded into system 100 by way of removable medium 130, I/O interface 135, or communication interface 140. In such an embodiment, the software is loaded into system 100 in the form of electrical communication signals 155. The software, when executed by processor 110, preferably causes processor 110 to perform one or more of the processes and functions described elsewhere herein.

In an embodiment, I/O interface 135 provides an interface between one or more components of system 100 and one or more input and/or output devices. Example input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing devices, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet, or other mobile device).

System 100 may also include optional wireless communication components that facilitate wireless communication over a voice network and/or a data network (e.g., in the case of a mobile device, such as a smart phone). The wireless communication components comprise an antenna system 170, a radio system 165, and a baseband system 160. In system 100, radio frequency (RF) signals are transmitted and received over the air by antenna system 170 under the management of radio system 165.

In an embodiment, antenna system 170 may comprise one or more antennae and one or more multiplexors (not shown) that perform a switching function to provide antenna system 170 with transmit and receive signal paths. In the receive path, received RF signals can be coupled from a multiplexor to a low noise amplifier (not shown) that amplifies the received RF signal and sends the amplified signal to radio system 165.

In an alternative embodiment, radio system 165 may comprise one or more radios that are configured to communicate over various frequencies. In an embodiment, radio system 165 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 165 to baseband system 160.

If the received signal contains audio information, then baseband system 160 decodes the signal and converts it to an analog signal. Then the signal is amplified and sent to a speaker. Baseband system 160 also receives analog audio signals from a microphone. These analog audio signals are converted to digital signals and encoded by baseband system 160. Baseband system 160 also encodes the digital signals for transmission and generates a baseband transmit audio signal that is routed to the modulator portion of radio system 165. The modulator mixes the baseband transmit audio signal with an RF carrier signal, generating an RF transmit signal that is routed to antenna system 170 and may pass through a power amplifier (not shown). The power amplifier amplifies the RF transmit signal and routes it to antenna system 170, where the signal is switched to the antenna port for transmission.

Baseband system 160 is also communicatively coupled with processor(s) 110. Processor(s) 110 may have access to data storage areas 115 and 120. Processor(s) 110 are preferably configured to execute instructions (i.e., computer programs, such as the disclosed software) that can be stored in main memory 115 or secondary memory 120. Computer programs can also be received from baseband processor 160 and stored in main memory 110 or in secondary memory 120, or executed upon receipt. Such computer programs, when executed, can enable system 100 to perform the various functions of the disclosed embodiments.

### 2. Process Overview

Embodiments of processes for high-performance matrix multiplication in the convolutional and/or fully connected layers of BNNs, TNNs, and TBNs will now be described in detail. While the processes, described herein, are illustrated with a certain arrangement and ordering of subprocesses, each process may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

2.1. Efficient Matrix Multiplication on CPUs

2.1.1. High-Performance GeMM

There are a number of high-performance methods for computing matrix multiplications. For the purposes of description, a left matrix of size m×k will be denoted as A, and a right matrix of size k×n will be denoted as B, and the product of the left matrix and right matrix will be denoted as C=AB. The dimensions m, n, and k may be referred to as the “height,” “width,” and “depth,” respectively, of matrix multiplication. Xᵢⱼ denotes the element X in row i and column j of a matrix.

Most modern libraries for machine-learning and linear algebra implement matrix multiplication by splitting the left matrix A along its rows, splitting the right matrix B along its columns, possibly splitting both the left and right matrices A and B along the depth, and then using a high-performance function, called an “inner-kernel” or “microkernel,” to compute small blocks of matrix C. Ref30 describes several ways in which matrices A, B, and C may be split. Algorithm 1 below represents matrix multiplication using one of the splitting techniques:

Algorithm 1: General High-Level GeMM Algorithm

```
Input :
      m, n, k - height, width, depth;
      A - left matrix m x k;
      B - right matrix k x n;
Output :
      C - matrix m x n, C = AB
for y←0; y<m; y←y+m_{blk} do
  m_{eff}←min (m_{blk}, m−y) ;
  A_{buf} [0 : m_{eff}−1] ←PackNRowsA (A, y , m_{eff}) ;
  for x←0; x<n; x←x+n_{blk} do
    n_{eff}←min (n_{blk}, n−x) ;
    B_{buf} [0 : n_{eff}−1] ←PackNColsB (B, x, n_{eff}) ;
    for d←0; d<k; d←d+k_{blk} do
      k_{eff}←min (k_{blk}, k−d) ;
      for c←0; c<n_{eff}; c←c+nₘₖ do
        for r←0; r<m_{eff}; r←r+mₘₖ do
          j←y+c; i←x+r;
          C [j : j+mₘₖ−1] [i : i+nₘₖ−1] ←
            microkernel (A_{buf} [r : r+mₘₖ−1] , B_{buf} [c : c+nₘₖ−1] , k_{eff}) ;
        end
      end
    end
  end
end
```

In Algorithm 1, left matrix A is split into blocks of m_{bik} rows, and values in those blocks are reordered by the function PackNRowsA, so that small blocks of the rows in left matrix A can be easily processed by the microkernel, implemented as microkernel, with the result stored in A_{buf}. Similarly, right matrix B is split into blocks of n bik columns, and values in those blocks are reordered by the function PackNColsB, so that small blocks of the columns in right matrix B can be easily processed by microkernel, with the result stored in B_{buf}. Then, Algorithm 1 extracts smaller blocks, including mₘₖ rows and k_{eff}≤k_{bik} columns from A_{buf}, and nₘₖ columns and k_{eff} rows from B buf. These blocks are multiplied by microkernel. Values of mₘₖ and nₘₖ, as well as the storage order of values in buffers A_{buf} and B_{buf} depend on the implementation of microkernel. Values of k_{bik}, m_{bik}, and n bik are independent of the microkernel. These values are chosen so that reordered buffers fit into the L2 cache of the CPU, and smaller buffers that are processed by microkernel fit into the L1 cache of the CPU. In this manner, the number of cache misses is minimized, which speeds up the matrix multiplication.

In the context of inference in a neural network, the right matrix B is a weights matrix that is usually small enough to fit into the L2 cache. Right matrix B does not change during inference by the neural network, and therefore, can be reordered and stored in a buffer in advance. Consequently, a simpler algorithm, such as Algorithm 2, can be used to compute convolutions:

Algorithm 2: New High-Level GeMM Algorithm

```
Input :
      m, n, k - height, width, depth;
      A - left matrix m x k;
      PackedB - pre-reordered right matrix k x n;
Output :
      C - matrix m x n, C = AB
for d←0; d<k; d←d+k_{blk} do
  k_{eff}←min (k_{blk}, k−d) ;
  for r←0; r<m; r←r+mₘₖ do
    A_{buf} [0 : m_{eff}−1] ←PackNRowsA (A, r, mₘₖ) ;
    for c←0; c<n; c←c+nₘₖ do
      C [r : r+mₘₖ−1] [c : c+nₘₖ−1] ←
        microkernel (A_{buf}, PackedB [c : c+nₘₖ−1] , k_{eff}) ;
    end
  end
end
```

In Algorithm 2, buffer A_{buf} is noticeably smaller, since it contains only mₘₖ rows and k_{eff}≤k_{bik} columns from the left matrix A. This is beneficial for inference on mobile devices, which generally have limited memory.

In both Algorithm 1 and Algorithm 2, the height m and width n are assumed to be multiples of the microkernel height mₘₖ and width nₘₖ, respectively. In practice, several microkernels of different shapes may be implemented to compute multiplication on matrices of arbitrary shape. Most computations are performed with a bigger microkernel, and the remaining computations are performed with smaller microkernels.

In an embodiment, the values mₘₖ and width nₘₖ are chosen to be as high as possible, to minimize the number of loads and stores from memory, but low enough that the result of matrix multiplication can be stored in CPU registers. Thus, in the inner loop, the microkernel can load values from a block of left matrix A and a block of right matrix B, multiply these values, and accumulate the results in the CPU registers. After the entire matrix multiplication is computed, the results can then be offloaded to memory. Accordingly, the shape of the microkernel depends on the number of registers available in the specific CPU architecture and the bit width of values used during the computation (i.e., the smaller the bit width, the more values can be stored in a single register). For example, CPUs in the 64-bit extension (AArch64) of the ARMv8 architecture have thirty-two 128-bit SIMD registers.

2.1.2. Integer GeMM

There are a number of key differences between floating-point matrix multiplication in CNNs and integer matrix multiplication in QNNs. Firstly, CNNs just multiply matrices. On ARM CPUs, the multiplication microkernel can use the floating-point-multiply-add (FMLA) instruction which, for three SIMD registers a, b, and c that each holds four 32-bit floating-point values, computes FMLA(a, b, c)=a+bc, element-wise.

In QNNs, integer computations are used to approximate the floating-point computations of CNNs. This can be done using linear quantization. In linear quantization, all floating-point values of the weights in a neural network layer, or of the activation function, are approximated with integers according to:

$$\hat{x} = max ( min ( ⌊ \frac{x}{s} - z ⌋ , Q ) , 0 )$$

wherein Q is a maximum quantized value, s is a floating-point value called “scale”, 0≤z<Q is an integer value called “zero-point” (i.e., \hat{0}=z), and └y┘ denotes the integer part of a value y. For n-bit quantization, Q=2ⁿ−1. Various strategies for obtaining the scale and zero-point are disclosed in Ref18, Ref19, and Ref29.

A quantized approximation of a matrix A will be denoted Â, with scale s_{A} and zero-point z_{A}. Similarly, a quantized approximation of a matrix B will be denoted \hat{B}, with scale s_{B} and zero-point z_{B}. Matrix multiplication can be approximated as:

$${C}_{ij} = {\sum }_{t = 1}^{k} {A}_{it} {B}_{tj} ≃ {\sum }_{t = 1}^{k} ( {s}_{A} ( {\hat{A}}_{it} - {z}_{A} ) {s}_{B} ( {\hat{B}}_{tj} - {z}_{B} ) ) = {s}_{A} {s}_{B} {\sum }_{t = 1}^{k} ( ( {\hat{A}}_{it} - {z}_{A} ) ( {\hat{B}}_{tj} - {z}_{B} ) ) = {s}_{A} {s}_{B} {\tilde{C}}_{ij}$$

wherein \tilde{C}ᵢⱼ can be computed using integer-only arithmetic. In an embodiment, \tilde{C}ᵢⱼ is computed with the following transformation, as described in Ref20 and Ref29:

$${\tilde{C}}_{ij} = {\sum }_{t = 1}^{k} ( ( {\hat{A}}_{it} - {z}_{A} ) ( {\hat{B}}_{tj} - {z}_{B} ) ) = {\sum }_{t = 1}^{k} ( {\hat{A}}_{it} {\hat{B}}_{tj} ) - {z}_{B} {\sum }_{t = 1}^{k} {\hat{A}}_{it} - {z}_{A} {\sum }_{t = 1}^{k} {B}_{tj} + {kz}_{A} {z}_{B}$$

wherein the first term represents matrix multiplication of quantized matrices: 8-bit multiplication with a 32-bit product in the case of GeMMlowp, and 4-bit multiplication with a 16-bit product in the case of Ref20. The second and third terms do not depend on j and i, respectively, which results in easier computation. In terms of algorithmic complexity, the first term requires O(mnk) operations, the second term requires O (mk) operations, the third term requires O(nk) operations, and the fourth term requires O(1) operations.

Notably, integer accumulators can overflow, which limits the depth of matrix multiplication. If matrices A and B hold p-bit values and their product is accumulated in q-bit accumulators, then the maximum depth that guarantees the absence of an overflow is:

$${k}_{max} = ⌊ \frac{{2}^{q} - 1}{{( {2}^{p} - 1 )}^{2}} ⌋$$

In GeMM-based convolution, this limits the number of channels in the input feature map (Ref20). For convolution with a Hₖ×Wₖ kernel, the maximum number of channels in the input feature map, for which the absence of an overflow is guaranteed, is:

$${C}_{in \_ max} = ⌊ \frac{{k}_{max}}{{H}_{k} {W}_{k}} ⌋$$

In an embodiment, binary logic operations are used instead of multiplications, and the results are accumulated in 16-bit integer values. This enables the disclosed algorithms to take full advantage of data-parallel computing, with the help of the NEON™ SIMD architecture extension of ARM CPUs.

2.2. Low-Bit Matrix Multiplication

Embodiments of algorithms for matrix multiplication of binary, ternary, and ternary-binary matrices will now be described. Matrix multiplication A×B=C is described for three cases:
BNN: A and B are binary, e.g., Aᵢⱼ∈{—1,1}, Bᵢⱼ∈{−1,1}.
TNN: A and B are ternary, e.g., Aᵢⱼ∈{−1,0,1}, Bᵢⱼ∈{−1,0,1}.
TBN: A is ternary and B is binary, e.g., Aᵢⱼ∈{−1,0,1}, Bᵢⱼ∈{−1,1}.
   For all cases, it is assumed that C holds integer values stored in signed 16-bit representation.

2.2.1. Values, Encoding, and Multiplication

In each of the disclosed algorithms, the values of matrix elements of matrices A and B are either binary or ternary. For binary values, single-bit encoding was used: x→x^{b}: 1→0, −1→1. Thus, matrix multiplication z=xy can be computed using the representation z^{b}=x^{b} ⊕y^{b}, in which ⊕ is an addition, modulo-2, or XOR operation. Using this representation, matrix multiplication can be computed using only XOR, bit-count, and addition operations in the inner loop:

$$c = {\sum }_{t = 1}^{k} {a}_{t} {b}_{t} = {\sum }_{t = 1}^{k} ( 1 - 2 {a}_{t}^{b} ⊕ {b}_{t}^{b} ) = k - 2 {\sum }_{t = 1}^{k} ( {a}_{t}^{b} ⊕ {b}_{t}^{b} )$$

For ternary values, 2-bit encoding was used: x→(x⁺, x⁻): 1→(1,0), 0→(0,0), −1→(0,1), wherein code (1,1) is invalid. Using these operations, ternary multiplication z=xy can be computed as:

(z⁺,z⁻)=((x⁺∧y⁺)∨(x⁻∧y⁻),(x⁺∧y⁻)∨(x⁻∧y⁺))

Ternary-binary multiplication u=xy can be computed as:

(u⁺,u⁻)=((x⁺∨y^{b})∨(x⁻∨y̅^̅{̅b̅}̅),(x⁺∨y̅^̅{̅b̅}̅)∧(x⁻∨y^{b}))

In both cases, the operator V denotes logical AND, the operator A denotes logical OR, and *̅ denotes logical NOT.

The following truth table illustrates these equations for ternary and ternary-binary multiplication:

Ternary Multiplication z = xy and Ternary-
Binary Multiplication u = xy

| x | y | z | x⁺ | x⁻ | y⁺ | y⁻ | y^{b} | z⁺ | z⁻ | u⁺ | u⁻ |
|---|---|---|---|---|---|---|---|---|---|---|---|
| 1 | 1 | 1 | 1 | 0 | 1 | 0 | 0 | 1 | 0 | 1 | 0 |
| 1 | 0 | 0 | 1 | 0 | 0 | 0 | — | 0 | 0 | — | — |
| 1 | −1 | −1 | 1 | 0 | 0 | 1 | 1 | 0 | 1 | 0 | 1 |
| 0 | 1 | 0 | 0 | 0 | 1 | 0 | 0 | 0 | 0 | 0 | 0 |
| 0 | 0 | 0 | 0 | 0 | 0 | 0 | — | 0 | 0 | — | — |
| 0 | −1 | 0 | 0 | 0 | 0 | 1 | 1 | 0 | 0 | 0 | 0 |
| −1 | 1 | −1 | 0 | 1 | 1 | 0 | 0 | 0 | 1 | 0 | 1 |
| −1 | 0 | 0 | 0 | 1 | 0 | 0 | — | 0 | 0 | — | — |
| −1 | −1 | 1 | 0 | 1 | 0 | 1 | 1 | 1 | 0 | 1 | 0 |

Assuming that aₜ bₜ=(c⁺, c⁻) is a ternary or ternary-binary multiplication of a couple of elements, as shown above, the dot product and matrix multiplication can be computed as:

$$c = {\sum }_{t = 1}^{k} {a}_{t} {b}_{t} = {\sum }_{t = 1}^{k} ( {( {a}_{t} , {b}_{t} )}^{+} - {( {a}_{t} , {b}_{t} )}^{-} )$$

Now that the encoding and operation definitions for matrix multiplication have been described, based on binary-logic operations available in the ARM instruction set, the microkernels for matrix multiplication will be described. Each microkernel multiplies mₘₖ rows stored in a buffer Ablock by nₘₖ columns stored in a buffer Bblock.

To describe a multiplication microkernel, the shape mₘₖ×nₘₖ of the multiplication microkernel, the storage order in buffers Ablock and Bblock, and the operations used in the computations must be specified. All of the microkernels, described below, have a shape of 16×8 and use sixteen 128-bit SIMD registers (i.e., c00, c01, . . . c07, c10, . . . c17) to hold the corresponding block of matrix C as 16-bit integers. However, storage order and SIMD instructions will be different for all multiplications (i.e., BNN, TNN, and TBN). It should be understood that the disclosed methods may be adapted to other shapes, register sizes, integer sizes, and/or the like.

2.2.2. Binary Microkernel

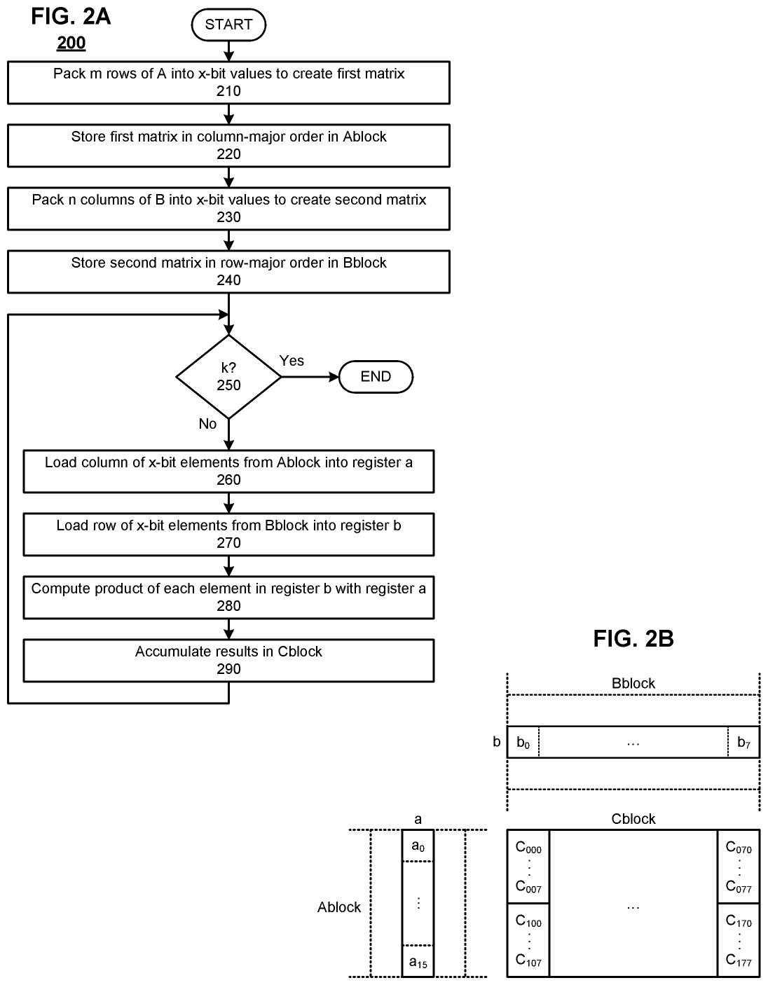

The binary microkernel will now be described. FIG. 2A illustrates a process 200 for matrix multiplication using a binary microkernel, according to an embodiment. FIG. 2B illustrates the registers used by the binary microkernel, according to an embodiment.

In subprocesses 210-220, values are packed into the buffer Ablock. In particular, in subprocess 210, m rows (e.g., m=16) from left matrix A, encoded as binary values, are packed into x-bit values (e.g., x=8). Each x-bit value consists of x bits from the corresponding row. Then, in subprocess 220, this x-bit matrix is stored in column-major order in Ablock. For instance, firstly, bits 1 to x from the first row are stored in Ablock, bits 1 to x from the second row are stored in the Ablock, and so on until the m-th row. Secondly, bits x+1 to 2 x from the first row are stored in Ablock, bits x+1 to 2 x from the second row are stored in Ablock, and so on until the m-th row. It should be understood that this may continue until all k elements from each row in left matrix A are stored in Ablock.

In subprocesses 230-240, values are packed into the buffer Bblock. In particular, in subprocess 230, n columns (e.g., n=8) from right matrix B, encoded as binary values, are packed into x-bit values (e.g., x=8). Each x-bit value consists of x bits from the corresponding column. Then, in subprocess 240, this x-bit matrix is stored in row-major order in Bblock. For instance, firstly, bits 1 to x from the first column are stored in Bblock, bits 1 to x from the second column are stored in Bblock, and so on until the n-th column. Secondly, bits x+1 to 2 x from the first column are stored in Bblock, bits x+1 to 2 x from the second column are stored in the buffer Ablock, and so on until the n-th column. It should be understood that this may continue until all k elements from each column in right matrix B are stored in Bblock.

In subprocesses 250-290, process 200 iterates over the depth dimension k in the microkernel. If another depth level remains in the depth dimension k (i.e., “No” in subprocess 250), process 200 completes another iteration of subprocesses 260-290. Otherwise, if all k depth levels have been evaluated (i.e., “Yes” in subprocess 250), process 200 ends with the result of the matrix multiplication stored in the buffer Cblock.

In subprocess 260, a column of x-bit elements are loaded from Ablock into a register a (e.g., sixteen 8-bit values into a 128-bit register). In subprocess 270, a row of x-bit elements are loaded from Bblock into one register b (e.g., eight 8-bit values into a 64-bit register). Then, in subprocess 280, for each x-bit element in register b, the XOR is computed of the x-bit element in register b with all elements in the column in register a. This XOR operation may be implemented using the bitwise exclusive-OR (EOR) instruction in ARM. In subprocess 290, the number of 1-bytes in the product of the XOR operation are counted and the result of the counting is accumulated in the corresponding register of CBlock. The counting may be implemented with the population-count-per-byte (CNT) instruction in ARM, and the accumulation may be implemented with the signed-add-wide (SADDW) instruction in ARM.

2.2.3. Ternary Microkernel

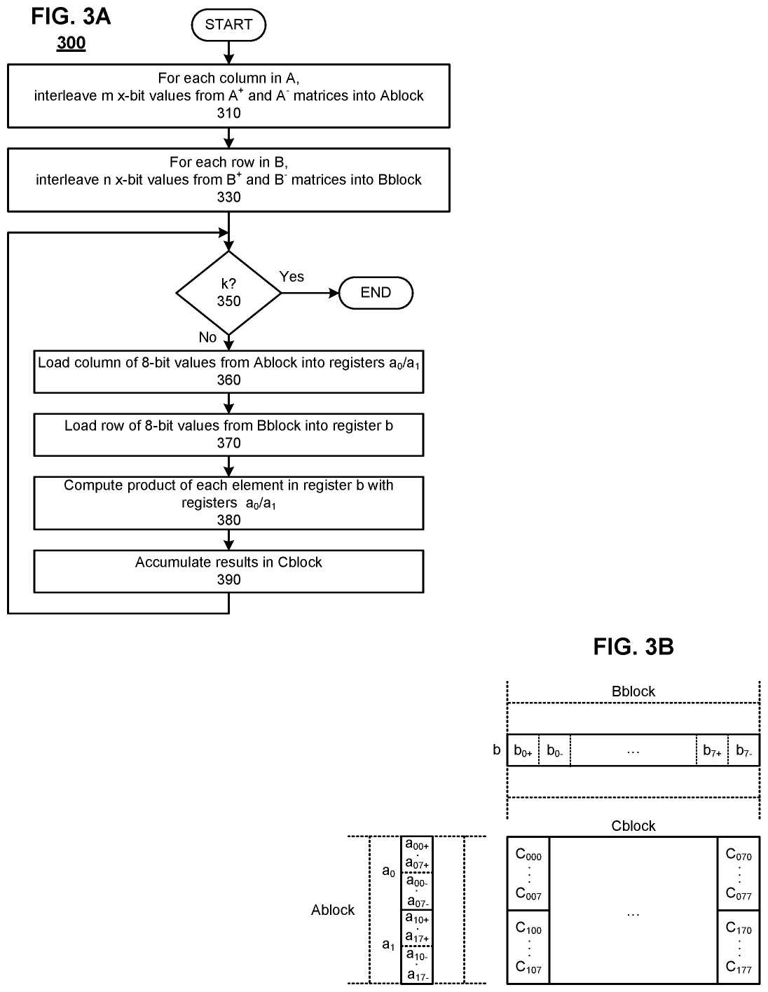

The ternary microkernel will now be described. FIG. 3A illustrates a process 300 for matrix multiplication using a ternary microkernel, according to an embodiment. FIG. 3B illustrates the registers used by the ternary microkernel, according to an embodiment. As discussed elsewhere herein, a 2-bit representation is used for the ternary values in both the left and right matrices.

In subprocess 310, values are packed into the buffer Ablock. With 2-bit encoding, the left matrix A may be represented as two separate matrices, consisting of A⁺ which comprises the values of all first bits of the 2-bit encoding, and A⁻ which comprises the values of all second bits of the 2-bit encoding. Firstly, m rows (e.g., m=16) from matrix A⁺, encoded as binary values, are packed into x-bit values (e.g., x=8) in an A⁺ block. Similarly, m rows from matrix A⁻, encoded as binary values, are packed into x-bit values in an A⁻ block. Each x-bit value consists of x bits from the corresponding row. Then, for each column, m x-bit values from the A⁺ block are interleaved with m x-bit values from the A⁻ block into Ablock. For example, if m=16 and x=8, the first eight 8-bit elements from the first column of the A⁺ block are stored into Ablock, then the first eight 8-bit elements from the first column of the A⁻ block are stored into Ablock, then the last eight 8-bit elements from the first column of the A⁺ block are stored into Ablock, then the last eight 8-bit elements from the first column of the A⁻ block are stored into Ablock, and this repeats for all k columns in matrix A.

In subprocess 330, values are packed into the buffer Bblock. With 2-bit encoding, the right matrix B may be represented as two separate matrices, consisting of B⁺ which comprises the values of all first bits of the 2-bit encoding, and B⁻ which comprises the values of all second bits of the 2-bit encoding. Firstly, n columns (e.g., n=8) from matrix B⁺, encoded as binary values, are packed into x-bit values in a B⁺ block. Similarly, n columns from matrix B⁻, encoded as binary values, are packed into x-bit values in a B⁻ block. Each x-bit value consists of x bits from the corresponding column. Then, for each row, elements from the B⁺ block are interleaved with elements from the B⁻ block into Bblock. For example, if n=8 and x=8, the first 8-bit element from the B⁺ block is stored into Bblock, then the first 8-bit element from the B⁻ block is stored into Bblock, then the second 8-bit element from the B⁺ block is stored into Bblock, then the second 8-bit element from the B⁻ block is stored into Bblock, and this repeats for all k rows in matrix B.

In subprocesses 350-390, process 300 iterates over the depth dimension k in the microkernel. If another depth level remains in the depth dimension k (i.e., “No” in subprocess 350), process 300 completes another iteration of subprocesses 360-390. Otherwise, if all k depth levels have been evaluated (i.e., “Yes” in subprocess 350), process 300 ends with the result of the matrix multiplication stored in the buffer Cblock.

In subprocess 360, a column of x-bit elements are loaded from ABlock into two registers a₀ and a₁ (e.g., thirty-two 8-bit values into two 128-bit registers). In subprocess 370, a row of x-bit elements are loaded from Bblock into one register b (e.g., sixteen 8-bit values into a 128-bit register). Then, in subprocess 380, for each pair of x-bit elements (i.e., representing 2-bit encoding) in register b, the product of that pair of elements with registers a₀ and a₁ is computed, using AND and OR operations. In subprocess 390, the sums of the first (i.e., “+”) and second (i.e., “−”) bits in the product are computed (e.g., using the CNT instruction in ARM), their differences are computed (e.g., using the signed-subtract-long (SSUBL) instruction in ARM), and the result is accumulated in the corresponding register of Cblock (e.g., using the Add (ADD) instruction in ARM).

2.2.4. Ternary-Binary Microkernel

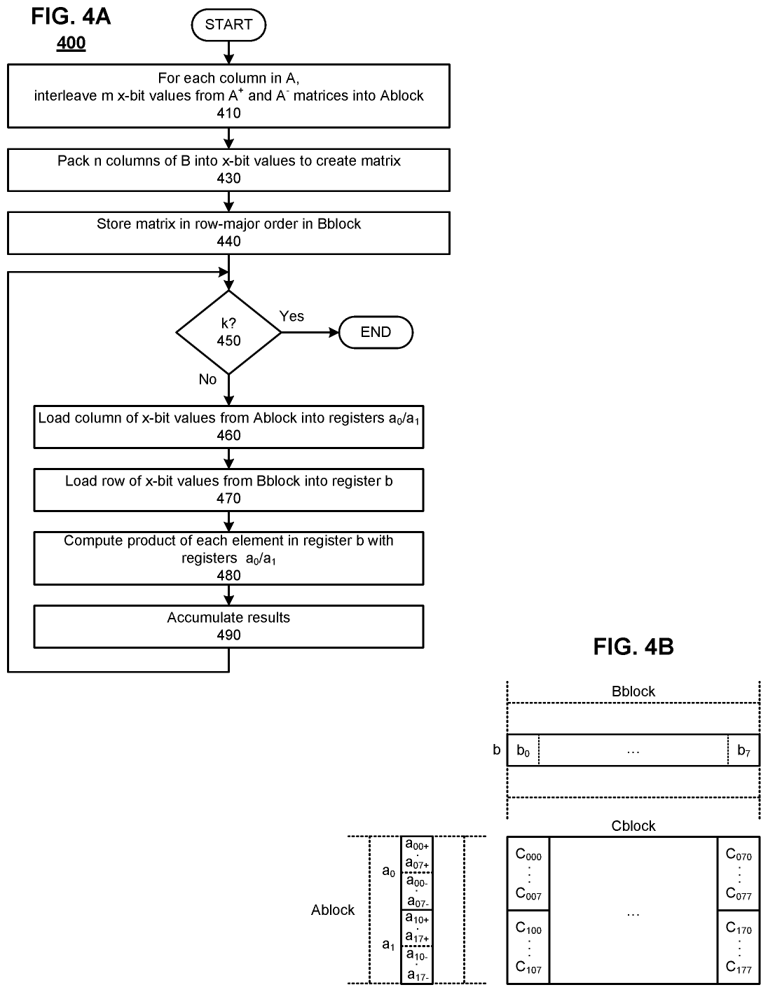

The ternary-binary microkernel will now be described. FIG. 4A illustrates a process 400 for matrix multiplication using a ternary-binary microkernel, according to an embodiment. FIG. 4B illustrates the registers used by the ternary-binary microkernel, according to an embodiment. Subprocess 410 may be similar or identical to subprocess 310, and subprocesses 430-440 may be similar or identical to subprocesses 230-240. Therefore, these subprocesses will not be redundantly described herein.

In subprocesses 450-490, process 400 iterates over the depth dimension k in the microkernel. If another depth level remains in the depth dimension k (i.e., “No” in subprocess 450), process 400 completes another iteration of subprocesses 460-490. Otherwise, if all k depth levels have been evaluated (i.e., “Yes” in subprocess 450), process 400 ends with the result of the matrix multiplication stored in the buffer Cblock.

In subprocess 460, a column of x-bit elements are loaded from Ablock into two registers a₀ and a₁ (e.g., thirty-two 8-bit values into two 128-bit registers). In subprocess 470, a row of x-bit elements are loaded from Bblock into one register b (e.g., eight 8-bit values into a 64-bit register). Then, in subprocess 480, for each x-bit element in register b, the product of that element with registers a₀ and a₁ is computed, using OR, AND, and ORN (i.e., OR with negation of the second operand) operations. In subprocess 490, the sums of the first (i.e., “+”) and second (i.e., “−”) bits in the product are computed (e.g., using the CNT instruction in ARM), their differences are computed (e.g., using the SSUBL instruction in ARM), and the result is accumulated in the corresponding register of the buffer Cblock (e.g., using the ADD instruction in ARM).

### 3. Evaluation

The performanceS of the disclosed algorithms, for BNN, TNN, and TBN matrix multiplication on ARM AArch64 CPUs, were evaluated against known computationally-efficient algorithms for the following data types: F32: 32-bit floating point using the same register layout as the GeMMlowp library; U8: 8-bit integer from the GeMMlowp library (Ref29); U4: 4-bit values from Ref20 with a microkernel upscaled to a size of 24×8, since the original size was 24×4 for the ARMv7 architecture; and binary from the daBNN library (Ref22).

3.1. Theoretical

The table below represents a comparison of the microkernels for the matrix multiplication algorithms under evaluation. The algorithms were compared by a number of columns in Ablock (m), a number of rows in Bblock (n), a step over depth per iteration (k), a number of computational instructions per iteration (COM, including FMLA for the F32 algorithm, unsigned-and-signed-long-multiply-with-optional-accumulate (UMLAL/UMLAL2) instructions for the U8 algorithm, etc.), a number of loads of the SIMD register per microkernel instruction (LD), a number of other SIMD instructions per iteration (MOV, including move, duplicate, insert, etc.), and a number of SIMD instructions per microkernel element (INS, calculated as INS=(COM+LD+MOV)/(nₘₖ)). A maximum depth of multiplication (kₘₐₓ) was also estimated for the U8 and U4 algorithms. In ternary and binary matrix multiplication, xy=z, |z|≤1, so kₘₐₓ is equal to the maximum possible value that a register can hold. Evaluated implementations of TNN, TBN, and BNN used 16-bit signed registers, such that kₘₐₓ=2¹⁵−1. daBNN uses 32-bit floating-point registers, with a 23-bit significand field, to store Cblock, such that kₘₐₓ=2²³−1.

Comparison of Matrix Multiplication Microkernels

| Algorithm | m × n × k | COM | LD | MOV | INS | kₘₐₓ |
|---|---|---|---|---|---|---|
| F32 | 12 × 8 × 1 | 24 | 5 | 0 | 0.302 | — |
| U8 | 12 × 8 × 2 | 48 | 5 | 5 | 0.302 | 66051 |
| U4 | 24 × 8 × 2 | 48 | 5 | 16 | 0.180 | 291 |
| TNN | 16 × 8 × 8 | 96 | 3 | 64 | 0.159 | 32767 |
| TBN | 16 × 8 × 8 | 96 | 3 | 56 | 0.151 | 32767 |
| BNN | 16 × 8 × 8 | 32 | 2 | 8 | 0.041 | 32767 |
| daBNN | 8 × 6 × 128 | 156 | 12 | 36 | 0.033 | 8388607 |

A matrix multiplication algorithm reaches maximal efficiency when the multiplication parameters of height, width, and depth are multiples of corresponding microkernel parameters m, n, and k, respectively. However, this limits the applicability of the matrix multiplication algorithm in CNNs. If a convolution is computed using the im2col transformation, the height is the number of pixels in the input feature map, the width is the number of filters (e.g., from only a few in upper layers of small CNNs to hundreds or thousands in lower layers of large CNNs). The kₘₐₓ limits the number of input channels in the feature maps. Taking all of the limitations into account, the U4 algorithm is only suitable for small CNNs. The daBNN algorithm, on the other hand, will show better results in large networks. The remaining algorithms, including TNN, TBN, and BNN, are suitable for small, medium, and large CNNs.

3.2. Experimental

Although the number of instructions (e.g., measured as COM, LD, MOV, and INS) can provide a general indication of which algorithm should have better computational efficiency, in practice, the efficiency also depends on cache misses (which in turn, depend on the order of loads and writes to memory) and the ability of the CPU to use the instruction pipelining (which in turn, depends on the order in which instructions are fetched). Furthermore, the overall efficiency of the matrix multiplication is also affected by reordering operations that prepare matrix blocks for the microkernel, and by post-processing in the U8 and U4 algorithms. Thus, the efficiencies of all of the algorithms were experimentally measured.

Matrix multiplication for the F32, U4, TNN, TBN, and TNN algorithms were implemented according to Algorithm 2. All microkernels were written in the ARMv8 assembly language to optimize the usage of SIMD registers. Time measurements were performed for different values of height H ∈{72, 120, 240, 360}, width W ∈{24, 48, 72, 96}, and depth D ∈{128, 256, 384, 512}. These values were chosen to be multiples of the microkernel size for each algorithm, in order to maximize the efficiency of each algorithm. These values are also representative of matrix multiplications in small and medium CNNs, which can be used in real-life tasks on the CPUs that are commonly found in mobile devices.

The experiments were run on the ARM Cortex-A73 CPU. For each value of the measured parameters, the median of five measurements was calculated to exclude random errors. The whole experiment was repeated fifty times, and the average of each measured parameter was calculated. The results are summarized in the table below, in which each cell compares a pair of algorithms A and B as E_{θ}(T_{B} (θ)/T_{A} (θ)), wherein T_{A} (θ) and T_{B} (θ) denote execution times of test θ, and E_{θ} is the mathematical expectation of test θ.

Efficiency Ratio of Matrix Multiplication Algorithms

| B\A | F32 | U8 | U4 | TNN | TBN | BNN | daBNN |
|---|---|---|---|---|---|---|---|
| F32 | 1.00 | 1.44 | 2.52 | 3.63 | 3.75 | 10.9 | 9.60 |
| U8 | 0.69 | 1.00 | 1.75 | 2.51 | 2.60 | 7.52 | 6.63 |
| U4 | 0.40 | 0.57 | 1.00 | 1.44 | 1.49 | 4.32 | 3.81 |
| TNN | 0.28 | 0.40 | 0.70 | 1.00 | 1.03 | 2.99 | 2.64 |
| TBN | 0.27 | 0.39 | 0.67 | 0.97 | 1.00 | 2.90 | 2.55 |
| BNN | 0.09 | 0.13 | 0.23 | 0.34 | 0.35 | 1.00 | 0.88 |
| daBNN | 0.11 | 0.15 | 0.27 | 0.39 | 0.40 | 1.15 | 1.00 |

As demonstrated by the results, the TNN algorithm significantly outperforms matrix multiplication for data types with greater bit-width. In particular, the TNN algorithm is 3.6 times faster than the F32 algorithm, 2.5 times faster than the U8 algorithm, and 1.4 times faster than the U4 algorithm. The TBN algorithm is only slightly (3%) faster than the TNN algorithm, because of a simple data flow in Bblock. The BNN algorithm is almost 3 times faster than the TNN algorithm and 2.9 times faster than the TBN algorithm. The BNN algorithm also turns out to be 12% faster than the daBNN algorithm, due to a bigger microkernel and the 16-bit representation of the result.

The disclosed algorithms for ternary, ternary-binary, and binary matrix multiplication exhibit significantly higher computational efficiency than algorithms with greater bit-widths. These algorithms are appropriate for the inference of low-bit CNNs on mobile devices, and do not pose strict constraints on the network architecture. However, to achieve maximum efficiency, the number of channels in the feature maps and convolutional filters should be multiples of eight. Notably, in the pursuit of high computational efficiency, different libraries for network inference usually implement direct convolution algorithms for the most common shapes of convolutional kernels that do not rely on matrix multiplication. For example, the daBNN library implements 3×3 binary convolution directly. The disclosed encoding and computation of ternary and binary dot products can be used in those algorithms as well.

### 4. Industrial Applicability

Low-bit QNNs are of great interest in practical applications, because they significantly reduce the consumption of both memory and computational resources. BNNs are computationally-efficient and memory-efficient, since they only require one bit per weight and activation, and can be computed using Boolean logic and bit count operations. QNNs with ternary weights and activations (i.e., TNNs) and binary weights and ternary activations (i.e., TBNs) aim to improve recognition quality, relative to BNNs, while preserving low bit-width. However, efficient implementations of these QNNs usually require ASICs and FPGAs, which limits their applicability to real-life tasks. At the same time, efficient recognition on mobile devices (i.e., using existing CPUs of mobile devices) is in high demand. However, other than disclosed embodiments, there are no known existing fast implementations of TBNs and TNNs.

Accordingly, embodiments of algorithms are disclosed for ternary, ternary-binary, and binary matrix multiplication on mobile devices implementing the ARM architecture. Binary weights are represented using 1-bit encoding, and ternary weights are represented using 2-bit encoding. This enables matrix multiplication to be performed as Boolean logic operations that can be computed on 128 bits simultaneously, using the NEON™ SIMD architecture extension of ARM CPUs. The results of the matrix multiplication are accumulated in 16-bit integer registers. Embodiments also use special reordering of values in left and right matrices. This allows efficient computation of a matrix product, while minimizing the number of loads and stores, relative to the daBNN algorithm. The disclosed algorithms can be used to implement inference of convolutional and fully connected layers of TNNs, TBNs, and BNNs.

The disclosed algorithms for ternary, ternary-binary, and binary matrix multiplication are superior to existing CPU implementations of matrix multiplication. They are 3.6 times faster than full precision algorithms, 2.5 times faster than 8-bit quantized algorithms, and 1.4 times faster than 4-bit quantized algorithms. They can be used in GeMM-based convolution implementations of CNNs over a wide range of parameters. This allows for computationally-efficient and resource-efficient inference of low-bit CNNs on mobile devices.

### 5. References

References are made herein to the following documents, which are all hereby incorporated herein by reference in their entireties:
Ref1: Wen et al., “The application of capsule neural network based CNN for speech emotion recognition,” in 2020 25th International Conference on Pattern Recognition (ICPR), IEEE, 2021, pp. 9356-9362;
Ref2: Teplyakov et al., “Line detection via a lightweight CNN with a Hough layer,” in International Conference on Machine Vision (ICMV) 2020, vol. 11605, no. 116051B, Bellingham, Washington 98227-0010 USA, Society of Photo-Optical Instrumentation Engineers (SPIE), January 2021, doi:10.1117/12.2587167;
Ref3: Ye et al., “Building detection by local region features in SAR images,” Computer Optics, vol. 44, no. 6, 2020;
Ref4: Kurnikov et al., “DNNs for multi-map semantic segmentation,” in ICMV 2020, vol. 11605, no. 1160517, Bellingham, Washington 98227-0010 USA, SPIE, January 2021, doi:10.1117/12.2587178;
Ref5: Dosovitskiy et al., “An image is worth 16×16 words: Transformers for image recognition at scale,” arXiv preprint arXiv:2010.11929, 2020;
Ref6: Liu et al., “SWIN transformer: Hierarchical vision transformer using shifted windows,” arXiv preprint arXiv:2103.14030, 2021;
Ref7: Tolstikhin et al., MLP-mixer: An all-MLP architecture for vision,” arXiv preprint arXiv:2105.01601, 2021;
Ref8: Yu et al., S2-MLP: Spatial-shift MLP architecture for vision,” in Proceedings of the IEEE/CVF Winter Conference on Applications of Computer Vision, 2022, pp. 297-306;
Ref9: Liu et al., “Are we ready for a new paradigm shift? A survey on visual deep MLP,” arXiv preprint arXiv:2111.04060, 2021;
Ref10: Gorospe et al., “A generalization performance study using deep learning neural networks in embedded systems,” Sensors, vol. 21, no. 4, p. 1031, 2021;
Ref11: Chellapilla et al., “High Performance Convolutional Neural Networks for Document Processing,” in 10th International Workshop on Frontiers in Handwriting Recognition, Lorette ed., Université de Rennes 1. La Baule, France, Suvisoft, October 2006, available hal.inria.fr/inria-00112631;
Ref12: Anderson et al., “High-performance low-memory lowering: GeMM-based algorithms for DNN convolution,” in 2020 IEEE 32nd International Symposium on Computer Architecture and High Performance Computing (SBAC-PAD), IEEE, 2020, pp. 99-106;
Ref13: Trusov et al., “p-im2col: Simple yet efficient convolution algorithm with flexibly controlled memory overhead,” IEEE Access, vol. 9, pp. 168162-168184, 2021, doi:10.1109/ACCESS.2021.3135690;
Ref14: Lavin et al., “Fast algorithms for convolutional neural networks,” in Proceedings of the IEEE Conference on Computer Vision and Pattern Recognition (CVPR), 2016, pp. 4013-4021;
Ref15: Sotiropoulos et al., “Porting a convolutional neural network for stereo vision in hardware,” in 2020 25th International Conference on Pattern Recognition (ICPR), IEEE, 2021, pp. 1313-1320;
Ref16: Georganas et al., “Anatomy of high-performance deep learning convolutions on SIMD architectures,” in SC18: International Conference for High Performance Computing, Networking, Storage and Analysis, IEEE, 2018, pp. 830-841;
Ref17: Jacob et al., “Quantization and training of neural networks for efficient integer-arithmetic-only inference,” in Proceedings of the IEEE CVPR, 2018, pp. 2704-2713;
Ref18: Banner et al., “Post-training 4-bit quantization of convolution networks for rapid-deployment,” arXiv preprint arXiv:1810.05723, 2018;
Ref19: Choukroun et al., “Low-bit quantization of neural networks for efficient inference,” in International Conference on Computer Vision (ICCV) Workshops, 2019, pp. 3009-3018;
Ref20: Trusov et al., “Fast implementation of 4-bit convolutional neural networks for mobile devices,” in Proceedings of International Conference on Pattern Recognition 2020, IEEE, May 2021, pp. 9897-9903, doi:10.1109/ICPR48806.2021.9412841;
Ref21: Rastegari et al., “Xnor-net: Imagenet classification using binary convolutional neural networks,” in European Conference on Computer Vision, Springer, 2016, pp. 525-542;
Ref22: Zhang et al., “daBNN: A super fast inference framework for binary neural networks on ARM devices,” 2019; Ref23: Bulat et al., “Xnor-net++: Improved binary neural networks,” arXiv preprint arXiv:1909.13863, 2019;
Ref24: Tang et al., “How to train a compact binary neural network with high accuracy?” in 31st AAAI conference on Artificial Intelligence, 2017;
Ref25: Alemdar et al., “Ternary neural networks for resource-efficient AI applications,” in 2017 International Joint Conference on Neural Networks (IJCNN), IEEE, 2017, pp. 2547-2554;
Ref26: Prost-Boucle et al., “Scalable high-performance architecture for convolutional ternary neural networks on FPGA,” in 2017 27th International Conference on Field Programmable Logic and Applications (FPL), IEEE, 2017, pp. 1-7;
Ref27: Deng et al., “GXnor-net: Training deep neural networks with ternary weights and activations without full-precision memory under a unified discretization framework,” Neural Networks, vol. 100, pp. 49-58, 2018;
Ref28: Wan et al., “TBN: Convolutional neural network with ternary inputs and binary weights,” in Proceedings of the European Conference on Computer Vision (ECCV), 2018, pp. 315-332;
Ref29: Jacob et al., “GeMMlowp: a small self-contained low-precision GeMM library,” 2017, github.com/google/gemmlowp; and
Ref30: Goto et al., “Anatomy of high-performance matrix multiplication,” ACM Transactions on Mathematical Software (TOMS), vol. 34, no. 3, pp. 1-25, 2008.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using an Advanced Reduced Instruction Set Computer (RISC) Machine (ARM) processor to execute a microkernel to perform matrix multiplication on a left matrix A of size m×k and a right matrix B of size k×n, wherein values in the left matrix A are represented using two-bit encoding, the microkernel comprising:
in an Ablock buffer, for each column in the left matrix A, interleaving m x-bit values from a set of first bits in the two-bit encoding with m x-bit values from a set of second bits in the two-bit encoding; and,
over k iterations,
loading a column of x-bit elements from the Ablock buffer into one or more a registers,
loading a row of x-bit elements from a Bblock buffer, in which a representation of the right matrix B is stored, into one or more b registers,
computing a product of each element in the one or more b registers with all elements in the one or more a registers, and
accumulating the products in a Cblock buffer.

2. The method of claim 1, wherein the microkernel is executed during convolution of a feature map with a convolution kernel during operation of a quantized neural network.

3. The method of claim 2, wherein the quantized neural network is a ternary neural network with ternary activation functions and ternary weights.

4. The method of claim 3, wherein the microkernel further comprises, prior to the k iterations, in the Bblock buffer, for each row in the right matrix B, interleaving n x-bit values from a set of first bits in the two-bit encoding with n x-bit values from a set of second bits in the two-bit encoding.

5. The method of claim 4, wherein m=16, n=8, and x=8, wherein the one or more a registers consist of two 128-bit registers, and wherein the one or more b registers consist of a single 128-bit register.

6. The method of claim 4, wherein computing a product comprises using AND and OR operations.

7. The method of claim 6, wherein accumulating the products comprises summing first and second bits of the two-bit encoding in the product using a population-count-per-byte (CNT) instruction in an ARM architecture, and subtracting first and second bits of the two-bit encoding in the product using a signed-subtract-long (SSUBL) instruction in the ARM architecture.

8. The method of claim 7, wherein accumulating the products further comprises accumulating results of the summing and subtracting using an add (ADD) instruction in the ARM architecture.

9. The method of claim 2, wherein the quantized neural network is a ternary-binary neural network with ternary activation functions and binary weights.

10. The method of claim 9, wherein the microkernel further comprises, prior to the k iterations:
packing n columns of right matrix B into x-bit values to create an x-bit matrix; and
storing the x-bit matrix in row-major order in the Bblock buffer.

11. The method of claim 10, wherein m=16, n=8, and x=8, wherein the one or more a registers consist of two 128-bit registers, and wherein the one or more b registers consist of a single 64-bit register.

12. The method of claim 10, wherein computing a product comprises using OR, AND, and ORN operations.

13. The method of claim 12, wherein accumulating the products comprises summing first and second bits of the two-bit encoding in the product using a population-count-per-byte (CNT) instruction in an ARM architecture, and subtracting first and second bits of the two-bit encoding in the product using a signed-subtract-long (SSUBL) instruction in the ARM architecture.

14. The method of claim 13, wherein accumulating the products further comprises accumulating results of the summing and subtracting using an add (ADD) instruction in the ARM architecture.

15. A non-transitory computer-readable medium having instructions stored therein, wherein the instructions, when executed by a processor, cause the processor to execute a microkernel to perform matrix multiplication on a left matrix A of size m×k and a right matrix B of size k×n, wherein values in the left matrix A are represented using two-bit encoding, the microkernel comprising:
in an Ablock buffer, for each column in the left matrix A, interleaving m x-bit values from a set of first bits in the two-bit encoding with m x-bit values from a set of second bits in the two-bit encoding; and,
over k iterations,
loading a column of x-bit elements from the Ablock buffer into one or more a registers,
loading a row of x-bit elements from a Bblock buffer, in which a representation of the right matrix B is stored, into one or more b registers,
computing a product of each element in the one or more b registers with all elements in the one or more a registers, and
accumulating the products in a Cblock buffer.

16. A method comprising using an Advanced Reduced Instruction Set Computer (RISC) Machine (ARM) processor to execute a microkernel to perform matrix multiplication on a left matrix A of size m×k and a right matrix B of size k×n, wherein values in both the left matrix A and the right matrix B are represented using one-bit encoding, the microkernel comprising:
packing m row of left matrix A into x-bit values to create a first x-bit matrix;
storing the first x-bit matrix in column-major order in an Ablock buffer;
packing n columns of right matrix B into x-bit values to create a second x-bit matrix;
storing the second x-bit matrix in row-major order in a Bblock buffer; and,
over k iterations,
loading a column of x-bit elements from the Ablock buffer into one or more a registers,
loading a row of x-bit elements from the Bblock buffer into one or more b registers,
computing a product of each element in the one or more b registers with all elements in the one or more a registers, and
accumulating the products in a Cblock buffer.

17. The method of claim 16, wherein m=16, n=8, and x=8, wherein the one or more a registers consist of a single 128-bit register, and wherein the one or more b registers consist of a single 64-bit register.

18. The method of claim 16, wherein computing the product comprises an XOR operation using a bitwise exclusive-OR (EOR) instruction in an ARM architecture.

19. The method of claim 18, wherein accumulating the products comprises counting a number of 1-bytes in the product using a population-count-per-byte (CNT) instruction in the ARM architecture.

20. The method of claim 19, wherein accumulating the products further comprises accumulating the counted numbers of 1-bytes using a signed-add-wide (SADDW) instruction in the ARM architecture.
